(19) United States
(12) Patent Application Publication
(10) Pub. No.: US 2006/0035655 A1
(43) Pub. Date: Feb. 16, 2006

(54) System and method for application distribution

(75) Inventors: Mikko Lonnfors, Helsinki (FI); Christophe Bouret, Helsinki (FI); Jari Kinnunen, Helsinki (FI); Esko Kokkonen, Espoo (FI); Olli Rantapuska, Vantaa (FI); Teemu Jalava, Espoo (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/916,356

(22) Filed: Aug. 11, 2004

(51) Int. Cl. H04Q 7/20

(52) U.S. Cl. 455/517

(57) ABSTRACT

A system and method for automatically installing an application and related information on a receiving terminal. When a transmitting terminal attempts to transmit information to a receiving terminal that does not possess an application required for receiving the information, the transmitting terminal provides the receiving terminal with information as to where the application can be found. The receiving terminal is then able to automatically obtain the application and related information from this location for subsequent installation.

### FIELD OF THE INVENTION

The present invention relates to the provision of services and/or applications to various devices. More particularly, the present invention relates to the provision of services and/or applications that utilize a communication mechanism to pass information between devices or terminals.

### BACKGROUND OF THE INVENTION

Currently, applications that are to be used in mobile terminals such as cellular telephones, personal digital assistants, and other devices are installed before the terminals are shipped to the customer. As a result of this phenomena, it is likely that all terminals, at least of a certain model, have the same set of applications when they are initially shipped.

In recent years, however, certain applications have begun to be provided by third parties. It is further anticipated that, in the future, more and more applications will be provided by third parties. These applications are typically developed using either native application program interfaces (APIs) provided by the terminal (for example, Symbian APIs) or Java APIs which can be made available regardless of the underlying operating system. As third party applications become more common, a likely result is that many applications will not installed onto all terminals that are otherwise similar and compatible.

As described above, third party application development can result in a situation where many applications are installed and developed after the terminal products have been shipped to customers. This may cause a number of complications when all terminals do not have same set of applications. This is a very undesirable situation because, in this situation, many communication attempts with other terminals will fail when the recipient terminal does not possess or support a required application. For example, if a transmitting terminal has a game program, and an attempt is made to transmit information to a recipient terminal using that game, if the recipient terminal does not have the game program installed, the game request will fail. Similar issues can result with other types of programs, including but not necessarily limited to gaming and messaging applications.

Currently some applications, particularly Java-based applications can be distributed using Over The Air (OTA) systems. In this arrangement, a terminal can fetch the Java application after it has learned the destination (URL) of the application. However, there is no standard mechanism for a terminal to distribute the application location information and ask other terminals to install a required application.

### SUMMARY OF THE INVENTION

The present invention provides a solution to above-identified problem by providing a system and a method for permitting required applications to be distributed to any parties that require the application. The present invention involves the use of a system where, if an application that is installed on a transmitting terminal attempts to communicate with a receiving terminal that does not support the application, the transmitting terminal transmits a request to the receiving terminal to “fetch” the application and related information from a designated site.

The present invention provides users of both the transmitting terminal and the receiving terminal with a number of distinct advantages. In particular, the present invention provides a convenient mechanism for distributing third party applications using standard protocols. This ultimately reduces the occurrences of a transmitting terminal being unable to transmit information to a receiving terminal due to the receiving terminal's lack of support of a given application. The present invention also provides the benefit of enabling the rapid and easy dissemination of application to a number of devices after the devices have been shipped to customers, providing third party developers with the ability to ensure that new applications can be quickly, easily and widely distributed.

One exemplary embodiment of the invention relates to a method of automatically installing an application on a receiving terminal. The method includes transmitting an invitation from a transmitting terminal to a receiving terminal, having the receiving terminal inform the transmitting terminal if the receiving terminal does not possess an installed application for processing the invitation, and transmitting a reference address from the transmitting terminal to the receiving terminal. The method further includes having the receiving terminal access a device located at the reference address, having the application downloaded from the device to the receiving terminal, and having the application installed on the receiving terminal.

Another exemplary embodiment relates to a computer program product for automatically installing an application on a receiving terminal. The computer program product includes computer code for receiving an invitation from a transmitting terminal, computer code for informing the transmitting terminal if the receiving terminal does not possess an installed application for processing the invitation, and computer code for receiving a reference address from the transmitting terminal. The computer code product also includes computer code for accessing a device located at the reference address in response to receiving the reference address from the transmitting terminal, computer code for downloading the application from the device, and computer code for installing the application.

Another exemplary embodiment relates to a computer program product for automatically providing an application to a receiving terminal. The computer code product includes computer code for transmitting an invitation from a transmitting terminal to the receiving terminal, computer code for having the transmitting terminal receive information that the receiving terminal does not possess an installed application for processing the invitation, and computer code for, in response to receiving the information, transmitting a reference address from the transmitting terminal to the receiving terminal, wherein the reference address corresponds to a device containing the application.

Another exemplary embodiment relates to a system for automatically installing an application. The system comprises a transmitting terminal including the application installed therein and a reference addressed stored therein, a receiving terminal configured for communication with the transmitting terminal, and a device corresponding to the reference address and containing the application for download therefrom. When the transmitting terminal transmits an invitation to the receiving terminal and the receiving terminal does not have the application installed for processing the invitation, the transmitting terminal transmits the reference address to the receiving terminal, and wherein upon receiving the reference address, the receiving terminal downloads the application from the device and installs the application.

Still another exemplary embodiment relates to an apparatus for automatically installing an application. The apparatus comprises a communication link and a memory unit operatively connected to the communication link. The memory unit can include computer code for receiving an invitation from a transmitting terminal, computer code for informing the transmitting terminal if the apparatus does not possess an installed application for processing the invitation, and computer code for receiving a reference address from the transmitting terminal. The memory unit can also include computer code for accessing a device located at the reference address in response to receiving the reference address from the transmitting terminal, computer code for downloading the application from the device, and computer code for installing the application.

Another exemplary embodiment relates to An apparatus for automatically installing an application. The apparatus comprises a communication link and a memory unit operatively connected to the communication link. The memory unit can include computer code for transmitting an invitation to a receiving terminal, computer code for receiving information that the receiving terminal does not posses an installed application for processing the invitation and computer code for transmitting a reference address corresponding to a device containing the application to the receiving terminal in response to receiving the information.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing the interaction between a transmitting terminal and a receiving terminal during which the receiving terminal obtains a required application from a network server;

FIG. 2 is a representation showing the interaction between a transmitting terminal and a receiving terminal during which the receiving terminal obtains a required application from the transmitting terminal;

FIG. 3 is an overview diagram of a system according to the present invention; and

FIG. 4 is a block diagram of a communication device that may correspond to a network device according to an embodiment of the present invention.

### DETAILED DESCRIPTION OF THE PREFERRED EMBODIMENTS

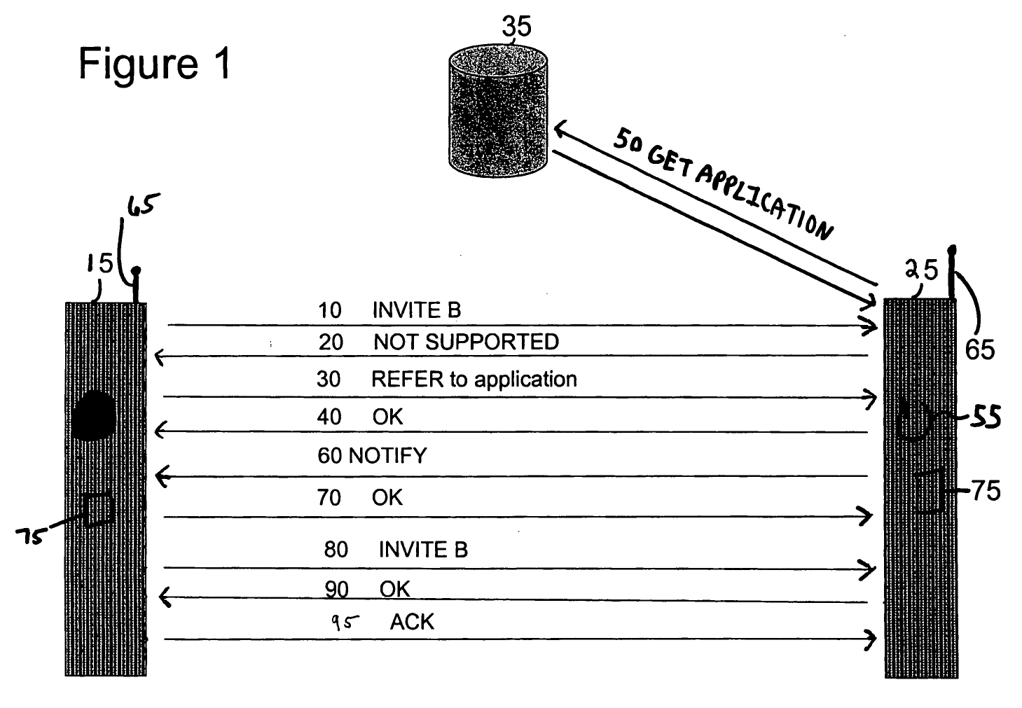

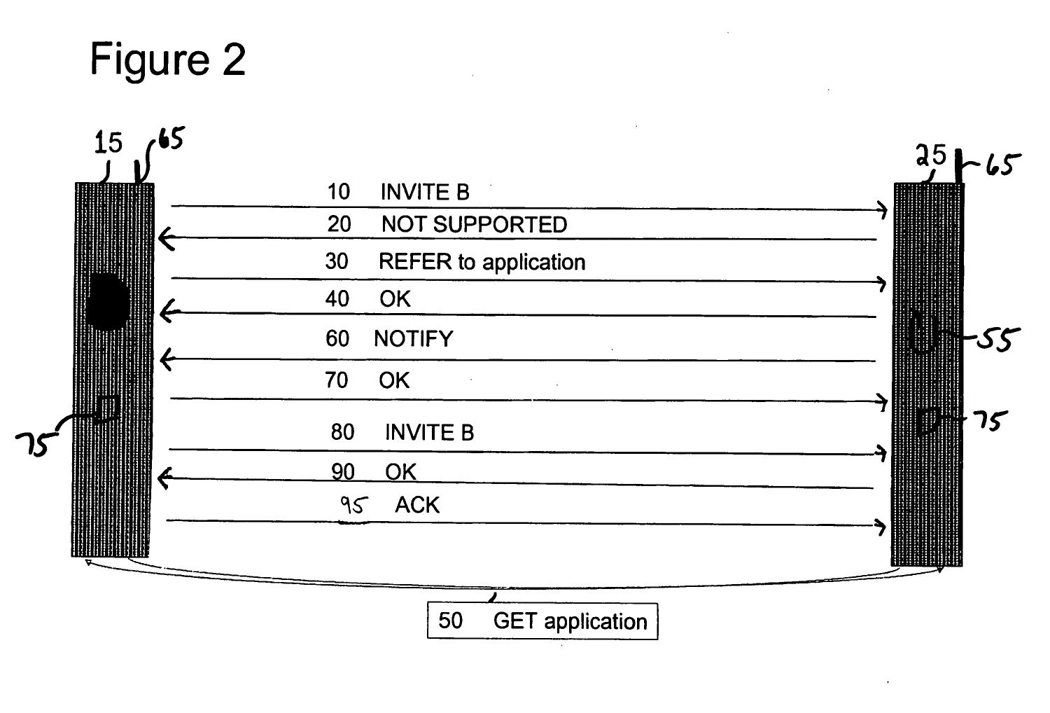

As is shown in FIGS. 1 and 2, the present invention provides a system and method for enabling a transmitting terminal 15 to request that a receiving terminal 25 obtain an application and related information so that the receiving terminal can communicate with the transmitting terminal. Both the transmitting terminal 15 and the receiving terminal 25 can take a wide variety of forms as discussed above. The transmitting terminal 15 includes a data communication link 65, which can be in either wired or wireless form, as well as a memory unit 75 for storing the computer programming and code needed to implement the features of the present invention. Similar items are included in the receiving terminal 25.

According to one embodiment of the invention, an application which is installed onto the transmitting terminal 15 attempts to communicate with the receiving terminal 25. This step is represented at 10 in FIGS. 1 and 2. If the receiving terminal 25 does not support the same application, the communication attempt will fail, and the receiving terminal 25 transmits information concerning this failure to the transmitting terminal 15 at step 20. In one embodiment of the invention, this failure is indicated in a protocol-specific manner. For example but without limitation, in the case where a Session Initiation Protocol (SIP) is used, the receiving terminal 25 may return appropriate status code, such as “488 Not Acceptable Here” for example.

In response to this failure notification, the transmitting terminal 15 instructs or requests that the receiving terminal 25 to fetch and install the correct application. In one embodiment of the invention, the transmitting terminal 15 can send a request to the receiving terminal 25 to fetch the application, as well as any related information that may be required or desired. The request can also contain a HTTP URL that can be used to locate and fetch the application. This operation can be performed by using a SIP REFER instruction, represented at step 30. In this situation, the referred-URL is the location of the application and could be in the form of “Refer-To: header”. As represented in FIG. 1, the referred-to URL can point to a network server 35 which hosts the application files. The referred-to URL can also be encoded into the application at the time it is initially distributed into the transmitting terminal 15.

In another embodiment of the invention and as depicted in FIG. 2, the transmitting terminal 15 hosts the application files itself (for example, by running a web server), and the HTTP URL simply directs the receiving terminal 25 back to the transmitting terminal 15. Using this system, the receiving terminal 25 is always aware where the required files are located, and the transmitting terminal 15 can be certain that the receiving terminal has obtained the correct application files.

The SIP REFER request or instruction can be used to inform the receiving terminal 25 that REFER is used to distribute the link to the new application. The REFER request or instruction can contain a body, which can be used for this purpose, or the REFER request or instruction can contain an “Accept-Contact: header” which contains this information (for example, “Accept-Contact: *;type=“application/install””.

If the receiving terminal 25 accepts the REFER request or instruction, the receiving terminal, in one embodiment of the invention, transmits a “202 Accepted” or “200 OK” response to the transmitting terminal 15, as represented at 40 in FIGS. 1 and 2. The receiving terminal 25 can execute the given HTTP URL and obtain the application at step 50. As discussed above, the application can be obtained from the network server 35, as shown in FIG. 1, or from the transmitting terminal 15, as shown in FIG. 2.

Once the required application has been downloaded, the receiving terminal 25 can automatically install the application at step 55. During the installation process, an application installer can inform the receiving terminal's SIP stack that all SIP messages having a certain application identifier should be dispatched to this new application.

After the installation is completed, the receiving terminal 25, sends a NOTIFY request to the transmitting terminal 15 at step 60, notifying the transmitting terminal 15 that the application has been installed. This is then acknowledged at step 70 by the transmitting terminal 15. Because the receiving terminal 25 now has the correct application, the initial invitation is capable of being successfully received. The transmitting terminal 15 then resends the initial invitation as shown at step 80. The receiving terminal answers the invitation by sending “200 OK” at step 90. Finally at step 95, the transmitting terminal 15 sends an acknowledgement message, “ACK”, to the receiving terminal 25 to confirm the reception of the final response.

Regarding the implementation of the present invention, the system for accomplishing the tasks described above can be included as part of the application when it is originally installed on the transmitting terminal 15. For example, the application software itself can contain the required code for transmitting and receiving the various messages described above and represented in FIGS. 1 and 2. The system for implementing the present invention can also be implemented using general middleware components or API. This implementation provides the added benefit of permitting the functionality to be accessed by all available applications, while also reducing the implementation required for each application.

On the side of the receiving terminal 25, in one embodiment of the invention the functionality is implemented so that it can be integrated with the SIP protocol stack and all available run time environments, including but not limited to Symbian and Java. Additionally, the system can instead be implemented on the receiving terminal 25 as a software middleware component. In this arrangement, the software middleware component must be able to handle SIP REFER requests, as well as be capable of transmitting required SIP NOTIFY requests. The software middleware component must also be able to fetch the application from the address which has been provided in the REFER request. Furthermore, the software middleware component must be able to initialize the application installation, as well as be capable of asking permission to perform these operations from the user of the receiving terminal 25.

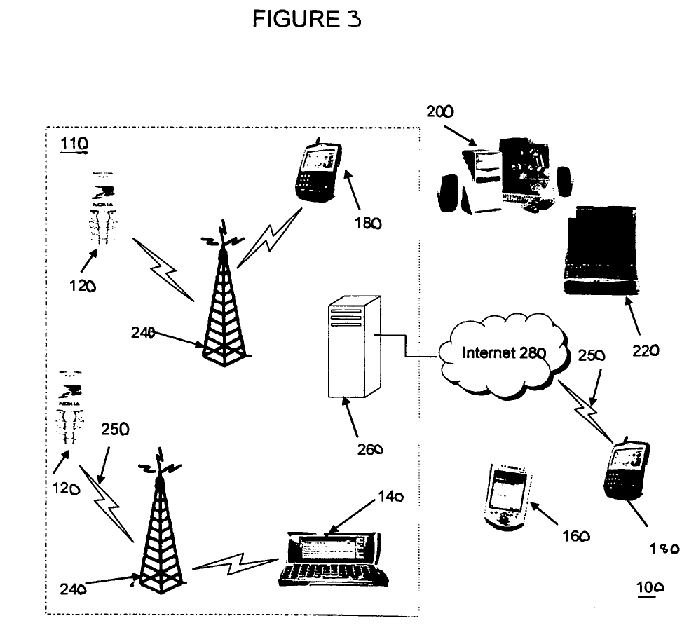

With reference to FIG. 3, a system 100 in which the present invention can be utilized is comprised of multiple communication devices that can communicate through a network. The system 100 may comprise any combination of wired or wireless networks including, but not limited to, a cellular telephone network, a wireless Local Area Network (LAN), a Bluetooth personal area network, an Ethernet LAN, a token ring LAN, a wide area network, the Internet, etc. The system 100 may include both wired and wireless communication devices. For example, the system 100 can include a cellular telephone network 110 and the Internet 280. Connectivity to the Internet 280 may include, but is not limited to, long range wireless connections, short range wireless connections, and various wired connections including, but not limited to, telephone lines, cable lines, power lines, and the like.

The exemplary communication devices of system 100 may include, but are not limited to, a cellular telephone 120, a combination PDA and cellular telephone 140, a PDA 160, an IMD 180, a desktop computer 200, and a notebook computer 220. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 250 to a base station 240. The base station 240 may be connected to a network server 260 that allows communication between the cellular telephone network 110 and the Internet 280. The system 100 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

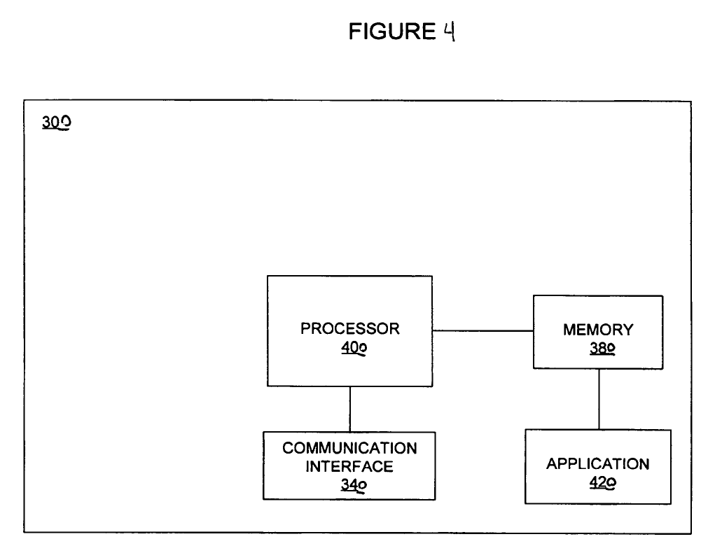

One possible implementation of the present invention is as part of a communication device (such as a mobile communication device like a cellular telephone, or a network device like a base station, router, repeater, etc.), which can constitute the transmitting terminal 15 and/or the receiving terminal 25. A communication device 300, as shown in FIG. 4, comprises a communication interface 340, a memory 380, a processor 400, and an application 420. The exact architecture of the communication device 300 is critical to the invention. Different and additional components of the communication device 300 may be incorporated into the communication device 300 and/or the system 100. For example, if the communication device 300 is a cellular telephone, it may also include a display screen and an input interface such as a keyboard or touch screen. Additionally, the device 300 need not include all of the components depicted in FIG. 4.

While preferred embodiments have been shown and described herein, it should be understood that changes and modifications can be made to the invention without departing from the invention in its broader aspects. For example, but without limitation, the particular messages that are transmitted between the transmitting terminal 15 and the receiving terminal 25 can take a variety of forms, depending upon the particular requirements of the respective systems. It is also possible that certain steps in the process described herein could be varied, eliminated and/or combined depending upon the particular system characteristics. Furthermore, the present invention can be used with virtually any application where devices are in communication with each other, regardless of the content involved. Various features of the invention are defined in the following Claims.

What is claimed is:

1. A method of automatically installing an application on a receiving terminal, comprising of:
transmitting an invitation from a transmitting terminal to the receiving terminal;
having the receiving terminal inform the transmitting terminal if the receiving terminal does not possess an installed application for processing the invitation;
transmitting a reference address from the transmitting terminal to the receiving terminal;
having the receiving terminal access a device located at the reference address;
having the application downloaded from the device to the receiving terminal; and
having the application installed on the receiving terminal.

2. The method of claim 1, wherein the device comprises a network server.

3. The method of claim 1, wherein the device comprises the transmitting terminal.

4. The method of claim 1, further comprising the step of having an acknowledgment transmitted from the receiving terminal to the transmitting terminal that the reference address has been received by the receiving terminal.

5. The method of claim 1, further comprising the step of having a notification from the receiving terminal to the transmitting terminal indicating that the installation has been completed.

6. The method of claim 5, further comprising the step of retransmitting the invitation from the transmitting terminal to the receiving terminal after the installation of the application has been completed.

7. The method of claim 1, wherein the application comprises a messaging application.

8. The method of claim 1, wherein the application comprises a gaming application.

9. A computer program product for automatically installing an application on a receiving terminal, comprising:
computer code for receiving an invitation from a transmitting terminal;
computer code for informing the transmitting terminal if the receiving terminal does not possess an installed application for processing the invitation;
computer code for receiving a reference address from the transmitting terminal;
computer code for accessing a device located at the reference address in response to receiving the reference address from the transmitting terminal;
computer code for downloading the application from the device; and
computer code for installing the application.

10. The computer program product of claim 9, wherein the device comprises a network server.

11. The computer program product of claim 9, wherein the device comprises the transmitting terminal.

12. The computer program product of claim 9, further comprising computer code for transmitting an acknowledgment to the transmitting terminal that the reference address has been received by the receiving terminal.

13. The computer program product of claim 9, further comprising computer code for transmitting a notification to the transmitting terminal indicating that the installation has been completed.

14. The computer program product of claim 9, further comprising computer code for re-receiving the invitation from the transmitting terminal to the receiving terminal after the installation of the application has been completed.

15. The computer program product of claim 9, wherein the application comprises a messaging application.

16. The computer program product of claim 9, wherein the application comprises a gaming application.

17. A computer program product for automatically providing an application to a receiving terminal, comprising:
computer code for transmitting an invitation from a transmitting terminal to the receiving terminal;
computer code for having the transmitting terminal receive information that the receiving terminal does not possess an installed application for processing the invitation;
computer code for, in response to receiving the information, transmitting a reference address from the transmitting terminal to the receiving terminal, wherein the reference address corresponds to a device containing the application.

18. The computer program product of claim 17, further comprising computer code for having the transmitting terminal receive an acknowledgment from the receiving terminal that the reference address has been received by the receiving terminal.

19. The computer program product of claim 17, wherein upon receiving the reference address, the receiving terminal accesses and installs the application from a device and wherein the computer program product further comprising computer code for having the transmitting terminal receive a notification from the receiving terminal indicating that the installation has been completed.

20. The computer program product of claim 17, upon receiving the reference address, the receiving terminal accesses and installs the application from a device and wherein the computer program product further comprising computer code for re-transmitting the invitation from the transmitting terminal to the receiving terminal after the installation of the application has been completed.

21. A system for automatically installing an application, comprising:
a transmitting terminal including the application installed therein and a reference addressed stored therein;
a receiving terminal configured for communication with the transmitting terminal; and
a device corresponding to the reference address and containing the application for download therefrom,
wherein when the transmitting terminal transmits an invitation to the receiving terminal and the receiving terminal does not have the application installed for processing the invitation, the transmitting terminal transmits the reference address to the receiving terminal, and wherein upon receiving the reference address, the receiving terminal downloads the application from the device and installs the application.

22. The system of claim 21, wherein the device comprises a network server.

23. The system of claim 21, wherein the device comprises the transmitting terminal.

24. The system of claim 21, wherein the transmitting terminal re-transmits the invitation to the receiving terminal after the installation of the application has been completed.

25. The system of claim 21, wherein the receiving terminal transmits an acknowledgment to the transmitting terminal that the reference address has been received by the receiving terminal.

26. The system of claim 21, wherein the receiving terminal transmits a notification to the transmitting terminal indicating that the installation has been completed

27. The system of claim 21, wherein the application comprises a messaging application.

28. The system of claim 21, wherein the application comprises a gaming application.

29. An apparatus for automatically installing an application, comprising:
a communication link; and
a memory unit operatively connected to the communication link, the memory unit including:
computer code for receiving an invitation from a transmitting terminal,
computer code for informing the transmitting terminal if the apparatus does not possess an installed application for processing the invitation,
computer code for receiving a reference address from the transmitting terminal,
computer code for accessing a device located at the reference address in response to receiving the reference address from the transmitting terminal,
computer code for downloading the application from the device, and
computer code for installing the application.

30. The apparatus of claim 29, wherein the application comprises a messaging application.

31. The apparatus of claim 29, wherein the application comprises a gaming application.

32. The apparatus of claim 29, wherein the memory unit further includes computer code for transmitting an acknowledgment to the transmitting terminal that the reference address has been received by the receiving terminal.

33. The apparatus of claim 29, wherein the memory unit further includes computer code for transmitting a notification to the transmitting terminal indicating that the installation has been completed.

34. The apparatus of claim 29, wherein the memory unit further includes computer code for re-receiving the invitation from the transmitting terminal to the receiving terminal after the installation of the application has been completed.

35. The apparatus of claim 29, wherein the apparatus is a mobile communications device.

36. The apparatus of claim 29, wherein the apparatus is a network device.

37. An apparatus for automatically installing an application, comprising:
a communication link; and
a memory unit operatively connected to the communication link, the memory unit including:
computer code for transmitting an invitation to a receiving terminal;
computer code for receiving information that the receiving terminal does not posses an installed application for processing the invitation; and
computer code for transmitting a reference address corresponding to a device containing the application for the application to the receiving terminal in response to receiving the information.

38. The apparatus of claim 37, wherein the memory unit further comprises computer code for receiving an acknowledgment from the receiving terminal that the reference address has been received by the receiving terminal.

39. The apparatus of claim 37, wherein the receiving terminal is configured to access and install the application from the device and wherein the memory unit further comprises computer code for receiving a notification from the receiving terminal indicating that the installation has been completed.

40. The apparatus of claim 39 further comprising computer code for retransmitting the invitation to the receiving terminal after installation has been completed.
